(19) United States
(12) Patent Application Publication
(10) Pub. No.: US 2011/0251348 A1
(43) Pub. Date: Oct. 13, 2011

(54) MODIFIED POLYMERS ON THE BASIS OF CONJUGATED DIENES OR OF CONJUGATED DIENES AND VINYL AROMATIC COMPOUNDS, A METHOD FOR THE PRODUCTION THEREOF AND THE USE THEREOF

(75) Inventors: Heike Kloppenburg, Duesseldorf (DE); Thomas Gross, Wulfrath (DE)

(73) Assignee: LANXESS DEUTSCHLAND GMBH, Leverkusen (DE)

(21) Appl. No.: 12/672,695

(22) PCT Filed: Aug. 8, 2008
(86) PCT No.: PCT/EP2008/060447

§ 371 Date: Jun. 28, 2011

(30) Foreign Application Priority Data
Aug. 16, 2007 (DE) 10 2007 038 442.6

(51) Int. Cl. C08G 18/83; C08G 18/08

(52) U.S. Cl. 525/131

(57) ABSTRACT

The present invention relates to polymers based on conjugated dienes or on conjugated dienes and vinylaromatic compounds, to a process for their preparation, and to their use.

The present invention relates to coupled modified diene polymers containing heteroatoms, to their preparation, and also to their use.

A known method, in particular for use in tyre construction, uses organic or inorganic compounds particularly suited to this purpose to link (couple) living, or preferably living, alkali-metal-terminated polymers based on conjugated dienes or based on conjugated dienes and on vinylaromatic compounds, the result being in particular an improvement in processing properties and also in physical and dynamic properties, in particular those connected to rolling resistance in tyres.

Linking agents/coupling agents used for the rubbers mentioned in industry are not only a very wide variety of organic compounds having appropriate groups capable of linking to the living polymers, e.g. epoxy groups (German Auslegeschrift 19 857 768), isocyanate groups, aldehyde groups, keto groups, ester groups, and also halide groups, and especially the corresponding compounds of silicon or of tin (EP-A 0 890 580 and EP-A 0 930 318), e.g. their halides, sulphides or amides. German Auslegeschrift 19 803 039 describes rubber compositions which are intended for high-performance tyre treads and some of whose underlying rubbers have been coupled using compounds of tin, of phosphorus, of gallium or of silicon.

There are likewise various known methods for end-group functionalization of polydienes. In the case of polybutadiene catalyzed by neodymium-containing systems, examples of compounds used are epoxides, substituted keto compounds from the group of the ketones or aldehydes, and other examples are acid derivatives and substituted isocyanates, as described by way of example in

U.S. Pat. No. 4,906,706. Another known method of end-group modification uses doubly functionalized reagents. These use the polar functional group to react with the polydiene and, using a second polar functional group in the molecule, interact with the filler, as described by way of example in WO 01/34658 or U.S. Pat. No. 6,992,147.

Some of the linking agents used hitherto have considerable attendant disadvantages, and by way of example in the case of diene polymerization reactions catalyzed by rare earths, in particular by neodymium-containing systems, they lead to end-group modification and are therefore unsuitable as coupling agents.

It was then an object of the present invention to provide modified diene polymers which avoid the disadvantages of the modified polymers used hitherto and which improve the ease of incorporation into rubber mixtures and the mechanical/dynamic properties of the resultant rubber mouldings. A particular intention is to improve the tear-propagation properties.

Surprisingly, the abovementioned disadvantages in the production of rubber mouldings using known modified polymers can now be avoided using the polymers modified according to the invention.

The present invention therefore provides modified polymers based on conjugated dienes or on conjugated dienes and on vinylaromatic compounds according to the formula (I) below:

[BR]ₙ-PUR

where
BR=diene polymer, vinylaromatic-diene copolymer,
PUR=main polyurethane unit and
n is greater than or equal to 2, preferably from 2 to 10.

For the purposes of the invention, the main polyurethane unit used preferably comprises a product mixture composed of a polyfunctional isocyanate and/or thioisocyanate (component A) with a polyfunctional H-acid compound (component B).

The component A used can comprise compounds of the polyfunctional isocyanates and/or thioisocyanates which are described by way of example in Ullmann's Enzyklopadie der technischen Chemie [Ullmann's Encyclopaedia of Industrial Chemistry], 4th Edition, Weinheim: Verlag Chemie, Volume 19, 1980, pages 303 to 304 and Volume 13, 1977, pages 347 to 358 or W. Siefken in Justus Liebigs Annalen der Chemie, 562, pages 75 to 136.

Component A includes at least one compound of the following structure

Q[NCX]q,

in which
q=a number greater than or equal to 2,
X=O or S, preferably O, and
Q is an oligomeric structure having from 4 to 1000 carbon atoms, preferably from 6 to 500 carbon atoms, where this structure can contain double bonds, or Q is an aliphatic hydrocarbon radical having from 2 to 200 carbon atoms, preferably from 6 to 100 carbon atoms, a cycloaliphatic hydrocarbon radical having from 4 to 200 carbon atoms, preferably from 5 to 10 carbon atoms, an aromatic hydrocarbon radical having from 6 to 200 carbon atoms, preferably from 6 to 13 carbon atoms, or an arylaliphatic hydrocarbon radical having from 8 to 200 carbon atoms, preferably from 8 to 12 carbons atoms, where, if appropriate, the oligomeric, aliphatic, cycloaliphatic, aromatic and arylaliphatic hydrocarbon radicals mentioned contain one or more heteroatoms from the group O, N, S.

Examples of suitable compounds of component A are ethylene diisocyanates, such as tetramethylene 1,4-diisocyanate; hexamethylene 1,6-diisocyanate (“HDI”); dodecane 1,12-diisocyanate; cyclobutane 1,3-diisocyanate; cyclohexane 1,3- and 1,4-diisocyanate; 1-isocyanato-3,3,5-trimethyl-5-isocyanatomethylcyclohexane; 2,4- and 2,6-hexahydrotoluene-diisocyanate; dicyclohexylmethane-4,4′-diisocyanate (“hydrogenated MDI” or “HMDI”); 1,3- and 1,4-phenylenediisocyanate; 2,4- and 2,6-toluenediisocyanate (“TDI”); diphenylmethane-2,4′- and/or -4,4′-diisocyanate (“MDI”); naphthylene 1,5-diisocyanate; triphenylmethane 4,4′,4″-triisocyanate; polymethylene poly(phenyl isocyanate), these being compounds that can be obtained via condensation of aniline with formaldehyde followed by phosgenation (“MDI”); norbornane diisocyanate; m- and p-isocyanatophenylsulphonyl isocyanate; modified polyisocyanates in which carbodiimide groups, urethane groups, allophanate groups, isocyanurate groups, or urea groups can be present, or oligomeric compounds, such as liquid diene polymers, which have isocyanate groups, e.g. polybutadienes containing isocyanate groups (“Krasol® LBD2000 and 3000”), where the isocyanate groups can be formed via the reaction of a polydiene containing hydroxy groups (e.g. compounds of the fundamental type represented by “Krasol® LBH”) with diisocyanates.

It is likewise possible to use reaction products composed of polyfunctional isocyanates and/or thioisocyanates (component A) with the polyfunctional H-acid compounds described below (compound B), where these contain free isocyanate groups.

It is preferable to use compounds which are soluble or miscible in non-polar aliphatic, cycloaliphatic or aromatic solvents. Preference is given here to the isocyanates of HDI, MDI, HMDI, TDI or Krasol® LBD type, these being readily commercially available.

For the purposes of the invention, the component B used can comprise polyfunctional H-acid compounds, among which are inter alia thiols, alcohols and/or amines as described by way of example in Ullmann's Encyklopadie der technischen Chemie [Ullmann's Encyclopaedia of Industrial Chemistry], 4th Edition, Weinheim: Verlag Chemie, Volume 19, 1980, pages 31 to 38 and pages 304 to 306.

Component B includes at least one compound of the structure B

T[YH]p,

in which
p=a number greater than or equal to 2,
Y=O, S or NR, where R is hydrogen, an aliphatic hydrocarbon radical having from 2 to 200 carbon atoms, preferably from 3 to 10 carbon atoms, a cycloaliphatic hydrocarbon radical having from 4 to 200 carbon atoms, preferably from 5 to 10 carbon atoms, an aromatic hydro-carbon radical having from 6 to 200 carbon atoms, preferably from 6 to 13 carbon atoms, or an arylaliphatic hydrocarbon radical having from 8 to 200 carbon atoms, preferably from 8 to 12 carbons atoms, where, if appropriate, each of the aliphatic, cycloaliphatic, aromatic and aryla-liphatic hydrocarbon radicals mentioned contains one or more heteroatoms from the group O, N, S.

T is an oligomeric structure having from 2 to 1000 carbon atoms, preferably from 2 to 100 carbon atoms, where this structure can contain double bonds and has been formed by way of example via polymerization of dienes with OH-containing comonomers, via polymerization of dienes with comonomers containing epoxy groups and subsequent hydrolysis, or subsequent substitution of an oligomer by OH-containing groups, or T is an aliphatic hydrocarbon radical having from 2 to 200 carbon atoms, preferably from 2 to 10 carbon atoms, a cycloaliphatic hydrocarbon radical having from 4 to 200 carbons atoms, preferably from 5 to 10 carbon atoms, an aromatic hydrocarbon radical having from 6 to 200 carbon atoms, preferably from 6 to 13 carbon atoms, or an arylaliphatic hydrocarbon radical having from 8 to 200 carbon atoms, preferably from 8 to 12 carbons atoms, where, if appropriate, each of the oligomeric, aliphatic, cycloaliphatic, aromatic and arylaliphatic hydrocarbon radicals mentioned contains one or more heteroatoms from the group O, N, S.

It is likewise possible to use reaction products composed of polyfunctional H-acid compounds with the polyfunctional isocyanates and thioisocyanates described above where these contain free H-acid groups.

It is preferable to use compounds which are soluble in non-polar aliphatic, cycloaliphatic or aro-matic solvents or which are miscible with non-polar aliphatic, cycloaliphatic or aromatic solvents. Compounds preferably used here are the H-acid compounds of the type represented by Krasol® LBH, ethylene glycol, glycerol, and substituted and unsubstituted compounds of the type represented by dihydroxybenzene, examples being tert-butylpyrocatechol or 1,2-, 1,3- and 1,4-dihydroxybenzene, these compounds being readily commercially available.

A PUR catalyst can be present during the reaction with the polyfunctional H-acid compounds. Addition of the PUR catalyst can take place at any desired juncture. It is advantageous that the PUR catalyst be added after the reaction of the diene polymers with compounds of component (A).

PUR catalysts that can be used comprise any of the known compounds described by way of example in Ullmann's Encyklopadie der technischen Chemie [Ullmann's Encyclopaedia of Industrial Chemistry], 4th Edition, Weinheim: Verlag Chemie, Volume 19, 1980, page 306. It is particularly advantageous to use tin compounds and amines, examples being dibutyltin dilaurate, stannous octoate or 1,4-diazabicyclo[2.2.2]octane.

For the purposes of the invention, the term BR includes diene polymers and vinylaromatic-diene copolymers prepared from conjugated dienes, e.g. 1,3-butadiene, 2,3-dimethyl-1,3-butadiene, 3-butyl-1,3-octadiene, isoprene, piperylene, 1,3-hexadiene, 1,3-octadiene, or 2-phenyl-1,3-butadiene, preferably 1,3-butadiene and isoprene, or from the conjugated dienes described above with vinylaromatics, e.g. styrene and divinylbenzene, preferably 1,3-butadiene, isoprene and styrene.

The average molar mass (M_{W}) (determined using GPC=gel permeation chromatography) of the inventive modified polymers is from 50 000 to 1 500 000 g/mol, preferably from 200 000 to 700 000 g/mol.

The quantitative ratio BR:PUR can be varied widely. PUR here is considered to be the entirety of components A and B. The quantitative ratio BR:PUR, based on the ratio by weight (g/g) is 100: from 0.01 to 30, preferably 100: from 0.02 to 10 and particularly preferably 100: from 0.05 to 5.

The invention further provides a process for the preparation of inventive polymers, where the compounds containing conjugated dienes are first polymerized alone or together with vinyl-aromatic compounds, and then these polymers are reacted with compounds of the polyfunctional isocyanates and/or thioisocyanates, and this polymer solution then obtained is reacted with poly-functional, H-acid compounds, preferably thiols, alcohols and/or amines.

The inventive coupled and modified polymers are preferably prepared in three steps. The first step prepares a diene polymer and/or vinylaromatic-diene copolymer.

The first step for preparation of the inventive polymers is generally carried out in such a way as to react a catalyst system with the respective monomer or with the monomers, in order to form the polymers.

The BR component is then prepared here by the processes known in the prior art. Catalysts used here preferably comprise compounds of the rare earth metals, as described in more detail by way of example in EP-A 011184 or EP-A 1245600. It is also possible to use any of the Ziegler-Natta catalysts known for the polymerization reaction, examples being those based on compounds of titanium, of cobalt, of vanadium or of nickel, or else based on compounds of the rare earth metals. The Ziegler-Natta catalysts mentioned can be used either alone or else in a mixture with one another. It is likewise possible to use anionic catalysts, e.g. systems based on butyllithium.

Ziegler-Natta catalysts based on compounds of the rare earth metals are preferably used, examples being compounds of cerium, of lanthanum, of praseodymium, of gadolinium or of neodymium, where these are soluble in hydrocarbons. The corresponding salts of the rare earth metals are particularly preferably used as Ziegler-Natta catalysts, examples being neodymium carboxylates, in particular neodymium neodecanoate, neodymium octanoate, neodymium naphthenate, neodymium 2,2-diethylhexanoate or neodymium-2,2-diethylheptanoate, and also the corresponding salts of lanthanum or of praseodymium. The Ziegler-Natta catalysts that can be used moreover also encompass catalysts systems based on metallocenes, as described by way of example in the following references: EP-A 919 574, EP-A 1025136 and EP-A 1078939.

The polymerization reaction can be carried out by conventional methods in one or more stages and, respectively, batchwise or continuously. The continuous method in a reactor cascade composed of a plurality of reactors in series, preferably at least 2, in particular from 2 to 5, is preferred.

This polymerization reaction can be carried out in a solvent and/or solvent mixture. Inert aprotic solvents are preferred, examples being paraffinic hydrocarbons, such as isomeric pentanes, hexanes, heptanes, octanes, decanes, 2,4-trimethylpentane, cyclopentane, cyclohexane, methyl-cyclohexane, ethylcyclohexane or 1,4-dimethylcyclohexane, or aromatic hydrocarbons, such as benzene, toluene, ethylbenzene, xylene, diethylbenzene or propylbenzene. These solvents can be used individually or in combination. Preference is given to cyclohexane and n-hexane. Blending with polar solvents is likewise possible.

The amount of solvent in the inventive process is usually from 1000 to 100 g, preferably from 500 to 150 g, based on 100 g of the entire amount of monomer used. It is, of course, also possible to polymerize the monomers used in the absence of solvents.

The polymerization reaction is preferably carried out in the presence of the abovementioned inert aprotic solvents.

The polymerization temperature can vary widely and is generally in the range from 0° C. to 200° C., preferably from 40° C. to 130° C. The reaction time likewise varies widely from a few minutes to a few hours. The polymerization is generally carried out within a period of from about 30 minutes to 8 hours, preferably from 1 to 4 hours. It can be carried out either at atmospheric pressure or else at elevated pressure (from 1 to 10 bar).

The inventive polymerization of the unsaturated monomers in the presence of the Ziegler-Natta catalysts mentioned can preferably be carried out as far as complete conversion of the monomers used. It is, of course, also possible to interrupt the polymerization reaction prematurely as a function of the desired properties of the polymer, for example at about 80% conversion of the monomers. The unconverted diene can by way of example be removed via a flash stage after the polymerization reaction.

In a second step, the diene polymers or vinylaromatic-diene copolymers are, after the polymeri-zation reaction, reacted with compounds of the polyfunctional isocyanates and/or thioisocyanates. The solvent or solvent mixture in which this is carried out is preferably the same as the aprotic organic solvent or solvent mixture used for preparation of the diene polymers or vinylaromatic-diene copolymers. It is also, of course, possible to change the solvent/solvent mixture, or to add the polyfunctional isocyanates and/or thioisocyanates in another solvent. Examples of aprotic organic solvents that can be used are: pentanes, hexanes, heptanes, cyclohexane, methylcyclopentane, benzene, toluene and ethylbenzene, preference being given to hexanes, cyclohexane, and toluene, and very particular preference being given to hexane.

The reaction of the diene polymers or vinylaromatic-diene copolymers with the compounds is preferably carried out in-situ without intermediate isolation of the polymers, and the diene poly-mers or vinylaromatic-diene copolymers here are first, after the polymerization reaction, reacted with compounds of the polyfunctional isocyanates and/or thioisocyanates (component A).

During this reaction it is preferable to exclude disruptive compounds which could impair the reaction. Examples of these disruptive compounds are carbon dioxide, oxygen, water, alcohols, and organic and inorganic acids.

The amount of organic solvents can readily be determined via appropriate preliminary experiments and is usually from 100 to 1000 g, preferably from 150 to 500 g, based on 100 g of the entire amount of monomer used.

The inventive process is usually carried out at temperatures of from 0° C. to 200° C., preferably from 30° C. to 130° C. The reaction can likewise be carried out at atmospheric pressure or else at elevated pressure (from 1 to 10 bar).

The reaction time is preferably relatively short. It is in the range from about 1 minute to about 1 hour.

This polymer solution then obtained is then, in a third step, reacted in-situ, preferably without intermediate isolation of the polymers, with polyfunctional, H-acid compounds, preferably thiols, alcohol and/or amines (component B).

For the reaction of the resultant polymer solution with component B, a PUR catalyst can likewise be used. This can involve the PUR catalyst listed above.

Amounts from 10 to 1000 ppm, based on the polymer, of the PUR catalyst can accelerate the reaction. The reaction is carried out at temperatures of from 0° C. to 150° C., preferably from 30° C. to 130° C. The reaction can be followed via titration of the NCO content or via evaluation of the NCO bands in the IR spectrum at from 2260 to 2275 cm⁻¹. Reaction times of less than 24 hours are generally adequate.

The molecular weight of the inventive coupled and modified polymers can vary widely. The number-average molecular weight is in the range from about 100 000 to about 2 000 000 for the conventional applications of the inventive polymers.

During the work-up it is possible to treat the reaction mixture with terminator reagents—as mentioned above—which contain active hydrogen, examples being alcohols or water or appropriate mixtures. It is moreover advantageous that antioxidants are added to the reaction mixture before the modified polymer is isolated.

The inventive polymer is isolated conventionally for example via steam distillation or flocculation using a suitable flocculent, such as alcohols. The flocculated polymer is then by way of example removed from the resultant fluid via centrifuging or extrusion. Residual solvent and other volatile constituents can be removed from the isolated polymer via heating, if appropriate under reduced pressure or in a current of air from a blower.

The usual compounding components can, of course, be added to the inventive polymers, examples being fillers, dye, pigments, softeners and reinforcing agents. The known rubber auxiliaries and crosslinking agents can moreover be added.

The inventive modified polymers can be used in a known manner for the production of vulcani-zates or of rubber mouldings of any kind.

When the inventive coupled and modified polymers are used in tyre mixtures it was possible by way of example to obtain a marked improvement in tear-propagation resistance in compounded materials comprising carbon black and in compounded materials comprising silica.

The invention moreover provides a use of the inventive modified polymers for the production of tyres and of tyre components, and of golf balls and of technical rubber items, and of rubber-reinforced plastics and of ABS plastics and HIPS plastics.

The examples below serve to illustrate the invention, but with no resultant limiting effect.

### EXAMPLES

The polymerization reactions were carried out with the exclusion of air and moisture, under nitrogen. Dry and oxygen-free technical-grade hexane was used as solvent. The polymerization reaction was carried out in an autoclave of 2 L to 20 L capacity, as appropriate for the batch size.

Conversions were determined gravimetrically; the polymer solutions here were weighed after the specimen was taken (still with solvent and monomer) and after drying (at 65° C. in a vacuum drying cabinet).

Mooney ML 1+4 (100) value was measured on equipment from Alpha using the large rotor, after one minute of preheating, over a period of 4 min at 100° C.

### Inventive Examples 1-17

A solution of diisobutylaluminium hydride in hexane (DIBAH; Al(C₄H₉)₂H), a solution of ethylaluminium sesquichloride in hexane (EASC, Al₂(C₂H₅)₃Cl₃) in equimolar amount with respect to the neodymium versatate and a solution of neodymium versatate in hexane (NdV, Nd(O₂C₁₀H₁₉)₃) were added to a solution of 13% by weight of 1,3-butadiene in technical-grade hexane in a dried 20 L steel reactor under nitrogen, with stirring. The mixture is then heated to a prefeed temperature of 73° C. The reaction is complete 60 min after the start of the reaction, and a polymer specimen is taken. HDI (component (A)) is then added by way of a burette with 100 ml of hexane, with stirring. After a further 30 min, ethylene glycol (component (B)) is added by way of a burette, together with the PUR catalyst dibutyltin laurate and 100 ml of hexane, with stirring. After one hour of reaction time, the polymer solution is stabilized by 2.6 g of the stabilizer Irganox 1520 dissolved in 100 ml of hexane, and the polymer is then precipitated with about 10 l of ethanol and dried at 60° C. in a vacuum drying cabinet.

The compounds used (diene polymer, component (A) and (B), PUR catalyst), their amounts, and the Mooney values for the individual polymer specimens, prior to and after modification and coupling, are stated in Tables 1 to 4.

TABLE 1

| Example | 1 | 2 | 3 | 4 | 5 | 6 |
|---|---|---|---|---|---|---|
| Hexane [g] | 8700 | 8700 | 8700 | 8700 | 8700 | 8700 |
| 1,3-Butadiene [g] | 1300 | 1300 | 1300 | 1300 | 1300 | 1300 |
| DIBAH 20% [ml] | 21 | 21 | 21 | 21 | 21 | 21 |
| EASC 20% [ml] | 2.5 | 2.5 | 2.5 | 2.5 | 2.5 | 2.5 |
| NdV 8.8% [ml] | 2.75 | 2.75 | 2.75 | 2.75 | 2.75 | 2.75 |
| HDI [g] (component A) | 3.9 | 3.5 | 2.3 | 2.3 | 2.3 | 1.6 |
| Ethylene glycol [g] | 1.5 | 1.3 | 0.9 | 0.9 | 0.6 | 0.9 |
| (component B) | | | | | | |
| Dibutyltin laurate [ml] | 0.15 | 0.15 | 0.15 | 0.15 | 0.15 | 0.15 |
| Mooney before modification | | | | | | |
| ML 1 + 4 (100) [MU] | 39 | 46 | 36 | 34 | 40 | 39 |
| Mooney after modification | | | | | | |
| ML 1 + 4(100) [MU] | 47 | 61 | 50 | 45 | 52 | 55 |

TABLE 2

| Example | 7 | 8 | 9 | 10 |
|---|---|---|---|---|
| Hexane [g] | 8500 | 8500 | 8500 | 8500 |
| 1,3-Butadiene in g | 1300 | 1300 | 1300 | 1300 |
| DIBAH 18.45% [ml] | 23 | 23 | 23 | 23 |
| EASC 20% [ml] | 2.5 | 2.5 | 2.5 | 2.5 |
| NdV 8.7% [ml] | 2.8 | 2.8 | 2.8 | 2.8 |
| Component A | HDI | HDI | HDI | HDI |
| Component A [g] | 2.3 | 2.3 | 1.6 | 2.3 |
| Component B | 4-tert- | 4-tert- | 4-tert- | Glyce- |
| | butylpyro- | butylpyro- | butylpyro- | rol |
| | catechol | catechol | catechol | |
| Component B [g] | 2.3 | 0.8 | 2.3 | 0.7 |
| Dibutyltin laurate [ml] | 0.5 | 0.5 | 0.5 | 0.15 |
| Mooney before modification | | | | |
| ML 1 + 4 (100) [MU] | 31 | 33 | 34 | 33 |
| Mooney after modification | | | | |
| ML 1 + 4 (100) [MU] | 45 | 44 | 43 | 46 |

TABLE 3

| Example | 11 | 12 | 13 | 14 |
|---|---|---|---|---|
| Hexane [g] | 8500 | 8500 | 8500 | 4350 |
| 1,3-Butadiene in g | 1300 | 1300 | 1300 | 650 |
| DIBAH 18.45% [ml] | 23 | 23 | 23 | 12 |
| EASC 20% [ml] | 2.5 | 2.5 | 2.5 | 1.2 |
| NdV 8.7% [ml] | 2.8 | 2.8 | 2.8 | 1.4 |
| Component A | HDI | HDI | HDI | HDI |
| Component A [g] | 2.3 | 2.3 | 2.3 | 1.2 |
| Component B | 4,4-para- | Poly BD | Poly BD | Vulkanox |
| | phenylene- | 605 E | 605 E | 4030 |
| | diamine | | | |
| Component B [g] | 3 | 4.2 | 8.3 | 2 |
| Dibutyltin laurate [ml] | 0.5 | 0.5 | 0.5 | 0.25 |
| Mooney before modification | | | | |
| ML 1 + 4 (100) [MU] | 45 | 46 | 29 | 35 |
| Mooney after modification | | | | |
| ML 1 + 4 (100) [MU] | 54 | 60 | 39 | 41 |

TABLE 4

| Example | 15 | 16 | 17 |
|---|---|---|---|
| Hexane [g] | 4350 | 4350 | 4350 |
| 1,3-Butadiene in g | 650 | 650 | 650 |
| DIBAH 18.45% [ml] | 12 | 12 | 12 |
| EASC 20% [ml] | 1.2 | 1.2 | 1.2 |
| NdV 8.7% [ml] | 1.4 | 1.4 | 1.4 |
| Component A | HDI | TDI | TDI |
| Component A [g] | 1.2 | 11.7 | 1.2 |
| Component B | Ethylene- | Ethylene | Ethylene |
| | diamine | glycol | glycol |
| Component B [g] | 0.5 | 0.4 | 0.4 |
| Dibutyltin laurate [ml] | none | 0.5 | 0.5 |
| Mooney before modification | | | |
| ML 1 + 4 (100) [MU] | 35 | 61 | 45 |
| Mooney after modification | | | |
| ML 1 + 4 (100) [MU] | 47 | 65 | 52 |

### Examples 18-26

The following substances were used for studies of the mixtures:

| Trade name | Manufacturer |
|---|---|
| Buna ™ CB 22/CB24 as non-functionalized | Lanxess Deutschland |
| polybutadiene | GmbH |
| Ultrasil 7000 GR as silica | KMF Laborchemie Handels |
| | GmbH |
| Si 69 as silane | Degussa Hills AG |
| Corax N 234 as carbon black | KMF Laborchemie Handels |
| | GmbH |
| Enerthene 1849-1 as oil | BP Oil Deutschland GmbH |
| Rotsiegel zinc white as zinc oxide | Grillo Zinkoxid GmbH |
| EDENOR C 18 98-100 (stearic acid) | Cognis Deutschland GmbH |
| Vulkanox ® 4020/LG as stabilizer | Bayer AG Brunsbuttel |
| Vulkanox ® HS/LG as stabilizer | Bayer Elastomeres S.A. |
| Vulkacit ® CZ/C as rubber chemical | Bayer AG Antwerpen |
| Vulkacit ® D/C as rubber chemical | Bayer AG Leverkusen |
| Ground sulphur 90/95 Chancel | Deutsche Solvay-Werke |

| Proportion of | | | | | |
|---|---|---|---|---|---|
| additives | | | | | |
| * Comparative | | | | | |
| examples | Unit | 18* | 19 | 20 | 21 |
| Buna ™ CB 24 | | 100 | | | |
| Example 3 | | | 100 | | |
| Example 5 | | | | 100 | |
| Example 6 | | | | | 100 |
| Carbon black (LRB 7, | | 60 | 60 | 60 | 60 |
| (N330)) | | | | | |
| Enerthene 1849-1 | | 15 | 15 | 15 | 15 |
| EDENOR C 18 98-100 | | 2 | 2 | 2 | 2 |
| Chancel 90/95 ground | | 1.5 | 1.5 | 1.5 | 1.5 |
| sulphur | | | | | |
| Vulkacit ® NZ/EGC | | 0.9 | 0.9 | 0.9 | 0.9 |
| zinc oxide (IRM 91, | | 3 | 3 | 3 | 3 |
| from U.S. Zinc) | | | | | |
| Mixture tests: | | | | | |
| ML 1 + 4/100 | MU | 83.9 | 84.1 | 90.2 | 89.3 |
| Vulcanizate tests: | | | | | |
| Test specimen: | | | | | |
| standard | | | | | |
| S2 specimen | | | | | |
| ShA hardness (70° C.) | Shore A | 60 | 59 | 60 | 60 |
| Graves DIN tear- | | | | | |
| propagation resistance | | | | | |
| Temperature 23° C. | | | | | |
| Average value for | mm | 2.14 | 2.23 | 2.26 | 2.48 |
| thickness | | | | | |
| F-Max | N | 129 | 165 | 171 | 198 |
| Tear-propagation | N/mm | 60.4 | 73.8 | 75.5 | 79.7 |
| resistance | | | | | |
| Test specimen: | | | | | |
| ASTM D624 B | | | | | |
| Crescent tear- | | | | | |
| propagation resistance | | | | | |
| Temperature 23° C. | | | | | |
| Average value for | mm | 2.04 | 2.35 | 2.23 | 2.44 |
| thickness | | | | | |
| F- Max | N | 85.1 | 195 | 222 | 200 |
| Tear-propagation | N/mm | 41.6 | 83.1 | 99.3 | 82 |
| resistance | | | | | |

| Examples | Unit | 22* | 23 | 24 | 25 | 26 |
|---|---|---|---|---|---|---|
| BUNA ™ CB 22 | | 100 | | | | |
| BUNA ™ CB 24 | | | 100 | | | |
| Example 1 | | | | 100 | | |
| Example 2 | | | | | 100 | |
| Example 4 | | | | | | 100 |
| Ultrasil 7000 GR | | 60 | 60 | 60 | 60 | 60 |
| Enerthene 1849-1 | | 15 | 15 | 15 | 15 | 15 |
| AKTIPLAST ST as processing aid | | 2 | 2 | 2 | 2 | 2 |
| from RheinChemie | | | | | | |
| EDENOR C 18 98-100 | | 2 | 2 | 2 | 2 | 2 |
| Vulkanox ® 4020/LG | | 1.5 | 1.5 | 1.5 | 1.5 | 1.5 |
| Vulkanox ® HS/LG | | 1.5 | 1.5 | 1.5 | 1.5 | 1.5 |
| SI 69 | | 4.8 | 4.8 | 4.8 | 4.8 | 4.8 |
| Rotsiegel zinc white | | 3.5 | 3.5 | 3.5 | 3.5 | 3.5 |
| Vulkacit ® CZ/C | | 1.8 | 1.8 | 1.8 | 1.8 | 1.8 |
| Vulkacit ® D/C | | 2 | 2 | 2 | 2 | 2 |
| Chancel 90/95 ground sulphur | | 1.5 | 1.5 | 1.5 | 1.5 | 1.5 |

Mixture tests:

| | | | | | | |
|---|---|---|---|---|---|---|
| ML 1 + 4/100 | MU | 79.7 | 60.2 | 64.1 | 74.6 | 63.2 |

Vulcanizate tests:
Test specimen: standard S2 specimen

| | | | | | | |
|---|---|---|---|---|---|---|
| ShA hardness | Shore A | 64.0 | 64.5 | 63.0 | 64.0 | 62.0 |
| (70° C.) | | | | | | |

Graves DIN 53515 tear-propagation resistance

| | |
|---|---|
| Temperature | 23° C. |

| | | | | | | |
|---|---|---|---|---|---|---|
| Average value for thickness | mm | 2.38 | 2.57 | 2.29 | 2.34 | 2.28 |
| F-Max | N | 44.6 | 52.9 | 55.6 | 73.8 | 63.9 |
| Tear-propagation resistance | N/mm | 18.8 | 20.6 | 24.2 | 31.6 | 28 |

Crescent tear-propagation resistance ASTM D624 B

| | |
|---|---|
| Temperature | 23° C. |

| | | | | | | |
|---|---|---|---|---|---|---|
| Average value for thickness | mm | 2.35 | 2.47 | 2.27 | 2.36 | 2.36 |
| F-Max | N | 60 | 69 | 87.6 | 77.5 | 115 |
| Tear-propagation resistance | N/mm | 25.5 | 28 | 38.6 | 32.9 | 48.5 |

What is claimed is:

1. Modified polymers based on conjugated dienes or on conjugated dienes and on vinylaromatic compounds according to the formula (I) below:
ti [BR]ₙ-PUR
where
BR=diene polymer, vinylaromatic-diene copolymer,
PUR=main polyurethane unit and
n is greater than or equal to 2.

2. Modified polymers according to claim 1, characterized in that the main polyurethane unit used comprises a product mixture composed of a polyfunctional isocyanate and/or thioisocyanate with a polyfunctional H-acid compound.

3. Modified polymers according to claim 1 or 2, characterized in that the H-acid compound used comprises thiols, alcohols and/or amines.

4. Modified polymers according to one or more of claims 1 to 3, characterized in that the polyfunctional isocyanate used comprises hexamethylene 1,6-diisocyanate, dicyclohexylmethane 4,4′-diisocyanate, toluene 2,4- and 2,6-diisocyanate, diphenylmethane-2,4′-diisocyanate and/or diphenylmethane 4,4′-diisocyanate.

5. Modified polymers according to one or more of claims 1 to 4, characterized in that the diene polymer used comprises compounds prepared from the following monomers: 1,3-butadiene, 2,3-dimethyl-1,3-butadiene, 3-butyl-1,3-octadiene, isoprene, piperylene, 1,3-hexadiene, 1,3-octadiene, 2-phenyl-1,3-butadiene.

6. Modified polymers according to one or more of claims 1 to 5, characterized in that the ratio by weight of BR to PUR is at least 100 g: 0.01 g to 30 g.

7. Process for the preparation of modified polymers according to one or more of claims 1 to 6, characterized in that the compounds containing conjugated dienes are first polymerized alone or together with vinylaromatic compounds, and then these polymers are reacted with compounds of the polyfunctional isocyanates and/or thioisocyanates, and this polymer solution then obtained is reacted with polyfunctional, H-acid compounds.

8. Use of the modified polymers according to one or more of claims 1 to 6 for the production of tyres and of tyre components, or else of HIPS plastics and ABS plastics, and of golf balls.
